(19) United States
(12) Patent Application Publication
(10) Pub. No.: US 2006/0120073 A1
(43) Pub. Date: Jun. 8, 2006

(54) Emergency ballast

(76) Inventors: Paul Kenneth Pickard, Conyers, GA (US); Antonio Marques, Covington, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/254,001

(22) Filed: Oct. 19, 2005

Related U.S. Application Data
(60) Provisional application No. 60/633,510, filed on Dec. 6, 2004.

(51) Int. Cl. F21S 4/00

(52) U.S. Cl. 362/217

(57) ABSTRACT

Emergency ballasts for powering fluorescent lights during power outages that have a reduced profile and do not require a bulky wiring tail. The emergency ballasts may include an external header that is associated with the internal circuitry of the ballast. A connector associated with the wiring of the other lighting fixture components may be inserted into or otherwise connected to the emergency ballast's header.

### RELATED APPLICATION

This Non-Provisional U.S. Patent Application claims the benefit of United States Provisional Application Serial No. 60/633,510, entitled “Emergency Ballast” and filed December 6, 2004, the entire contents of which are herein incorporated by this reference.

### FIELD OF THE INVENTION

This invention is related to ballasts for providing emergency lighting during a power outage and methods for installing the same.

### BACKGROUND OF THE INVENTION

Fluorescent light fixtures may include an emergency ballast, also know as an inverter, that lights the fixture's fluorescent lamps (sometimes at a reduced lumen output) during a power outage. Circuitry in the emergency ballast monitors the external electric lines powering the fluorescent light fixture. During a power outage, the emergency ballast powers the lights using one or more batteries located within the ballast's housing. Once the power is restored, the emergency ballast may automatically recharge the batteries in anticipation of the next power outage.

Typically, the emergency ballast installs under the fluorescent lighting fixture's channel cover in the “wireway,” along with the fluorescent ballast, which facilitates lighting the fluorescent lamps under normal operating conditions. Depending on its configuration, installation of the emergency ballast may require wiring it to the fluorescent ballast, the fluorescent lamps, a power source, a test switch and/or a pilot light. A large number of wires is necessary to connect the emergency ballast to the other fixture components (typically between 10-20 wires).

Typical emergency ballasts are manufactured with a “wiring tail” emerging from one or both ends of the ballast. The wiring tail includes the wiring necessary to connect the emergency ballast to the wires associated with the other components of the fixture. An internal connector, or “header,” associates the wires of the wiring tail with the circuitry of the emergency ballast. From the header, the wiring tail exits the housing of the emergency ballast through one or more apertures. The wires of the tail are typically two to five feet long to allow for installation in fixtures having differing locations and orientations of components.

Typical emergency ballasts that include a wiring tail internally connected to the emergency ballast's circuitry may be undesirable. First, because the wiring is internally connected to the ballast's circuitry, the wiring must be installed at the time of manufacture, increasing the complexity and expense of the manufacturing and testing processes. The bulky wiring tail may complicate the handling of the ballast during manufacture and testing. Second, in typical emergency ballasts, edges of the aperture in the ballast through which the wiring tail passes may rub or strip the insulation from the wires. Consequently, provisions must be made to protect the wiring's insulation from being damaged by the housing. Such provisions may increase the cost and complexity of the manufacturing process and may increase the size and/or profile of the housing (which is undesirable in low-profile applications). Third, during installation of the ballast, the installer often must shorten one or more of the wiring tail wires to fit all of the components and their associated wiring into the sometimes tight confines of the channel cover. This wasted wire unnecessarily increases the cost of the emergency lighting ballast product. Fourth, typical emergency ballasts are relatively difficult and time consuming to install and replace because the wiring tail must be connected to and disconnected from (respectively) the wires of the other components of the fluorescent fixture using wiring nuts, push nuts or other suitable devices. Replacement of typical emergency ballasts requires the installer to cut the wires of the old ballasts and attach the wires of the new ballast using additional wiring or push nuts. This is often extremely tedious and time consuming. Moreover, mismatching of wires between the existing fixture and the new emergency lamp ballast can lead to malfunction or failure of the emergency ballast and/or other components of the fixture. Fifth, testing of typical emergency ballasts is also relatively time consuming because the wiring tail wires must be individually connected to the testing equipment.

Finally, typical emergency ballasts may be undesirable because they are relatively difficult to reduce in profile. The advent of reduced diameter fluorescent light tubes has facilitated the production of fluorescent fixtures with reduced profiles. Reduced profile fixtures require smaller channel covers, which in turn require the emergency ballast and other components to have reduced profiles also. Typical emergency ballasts are more difficult to reduce in profile because the internal wiring tail connection requires a substantial amount of space and also requires the provisions for protecting the wiring tail as discussed above.

### SUMMARY OF THE INVENTION

Emergency ballasts of this invention, like typical emergency ballasts, provide power to fluorescent lights during power outages. Unlike typical emergency ballasts, the ballasts of this invention may have a reduced profile and not require a bulky wiring tail. Rather, ballasts of this invention include an external header that is associated with the internal circuitry of the ballast. A connector associated with the wiring of the other lighting fixture components may be inserted into or otherwise connected to the emergency ballast's header. The connector may be a “poke home” connector (also known as a “push nut,” “push wire” or “poke in” connector) and may be associated with the wiring of the other components simply by inserting the wires into corresponding apertures in the connector. Connecting the connector to the header electrically connects the other components of the lighting fixture to the emergency lighting ballast.

Emergency ballasts with external wiring connections may be desirable over typical emergency ballasts with wiring tails for a number of reasons. Because a bulky wiring tail does not have to be connected to the emergency ballasts during manufacture, the ballasts are easier to handle during manufacturing. Additionally, the ballasts of embodiments of this invention do not require provisions for protecting the wires' insulation from rubbing on the housing because the wiring does not pass through the housing. Also advantageously, installation of ballasts according to embodiments of the present invention does not necessarily result in wire waste because the ballast may be directly connected, through the intermediate connector, to the wiring of the other components.

The emergency ballast may be connected to the fixture's other components simply by connecting the wires of the other components to a connector and then securing the connector into the header of the ballast. In this way, a ballast is replaced easily by disconnecting the connector from the old ballast, removing the old ballast from the fixture, and connecting the wiring connector with the header of a new ballast. Thus, matching of wires between the new ballast and fixture components is automatic, minimizing the risk of human error. The external connector of the emergency ballast also facilitates the simple connection of a test switch and/or a pilot light to the emergency ballast. Also, embodiments of the present invention are also relatively easier to manufacture in a low profile configuration because space need not be provided in the ballast to connect the wiring tail to the other circuitry.

### BRIEF DESCRIPTION OF DRAWINGS

FIG. 1 is a schematic cross section view of an emergency lighting ballast according to an embodiment of the present invention installed in the wire way of a fluorescent light fixture.

FIG. 2 is a perspective view of an emergency lighting ballast according to another embodiment of the present invention.

FIG. 3 is a right side elevation view of the emergency lighting ballast of FIG. 2.

FIG. 4 is a left side elevation view of the emergency lighting ballast of FIG. 2.

FIG. 5 is a front elevation view of the emergency lighting ballast of FIG. 2.

FIG. 6 is a rear elevation view of the emergency lighting ballast of FIG. 2.

FIG. 7 is a top view of the emergency lighting ballast of FIG. 2.

FIG. 8 is a bottom view of the emergency lighting ballast of FIG. 2.

FIG. 9 is a perspective view of an emergency lighting ballast according to another embodiment of the present invention.

FIG. 10 is a right side elevation view of the emergency lighting ballast of FIG. 9.

FIG. 11 is a left side elevation view of the emergency lighting ballast of FIG. 9.

FIG. 12 is a front elevation view of the emergency lighting ballast of FIG. 9.

FIG. 13 is a rear elevation view of the emergency lighting ballast of FIG. 9.

FIG. 14 is a top view of the emergency lighting ballast of FIG. 9.

FIG. 15 is a bottom view of the emergency lighting ballast of FIG. 9.

FIG. 16 is a perspective view of a connector and a test switch/pilot light secured to the emergency lighting ballast of FIG. 2.

FIG. 17 is a perspective view of a connector and a test switch/pilot light secured to the emergency lighting ballast of FIG. 9.

FIG. 18 is a perspective view of the test switch/pilot light of FIGS. 16 and 17.

FIG. 19 is a perspective view of the connector of FIGS. 16 and 17.

FIG. 20 is a plan view of the inside of the top shell of the emergency lighting ballast shown in FIG. 2.

FIG. 21 is a top plan view of the emergency lighting ballast shown in FIG. 2 with the top shell removed.

FIG. 22 is a plan view of the inside of the top shell of the emergency lighting ballast shown in FIG. 9.

FIG. 23 is a top plan view of the emergency lighting ballast shown in FIG. 9 with the top shell removed.

### DETAILED DESCRIPTION OF DRAWINGS

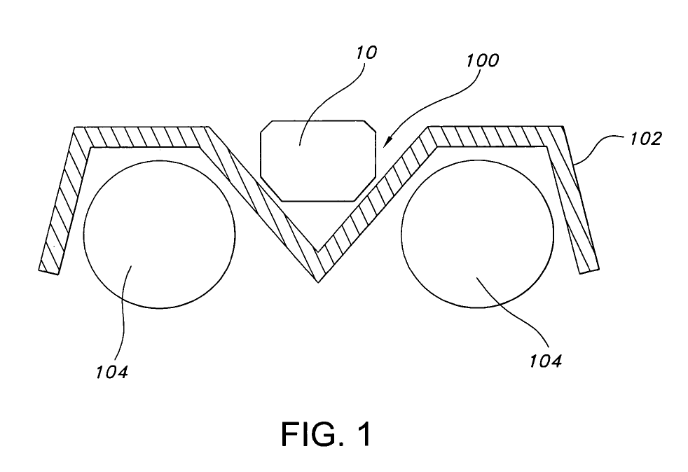

FIG. 1 schematically shows an emergency ballast 10 of the present invention installed in the wire way 100 of a fluorescent light fixture 102, which includes two fluorescent lights 104.

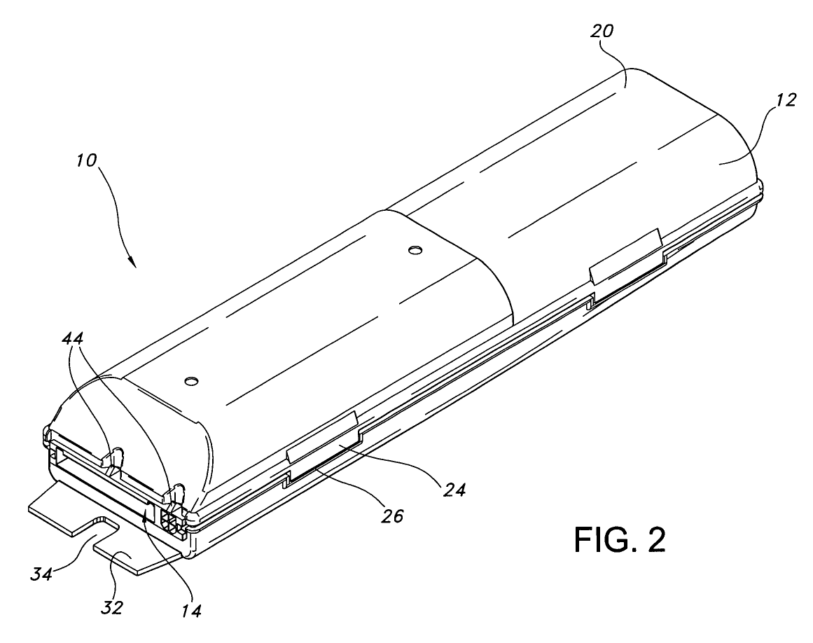

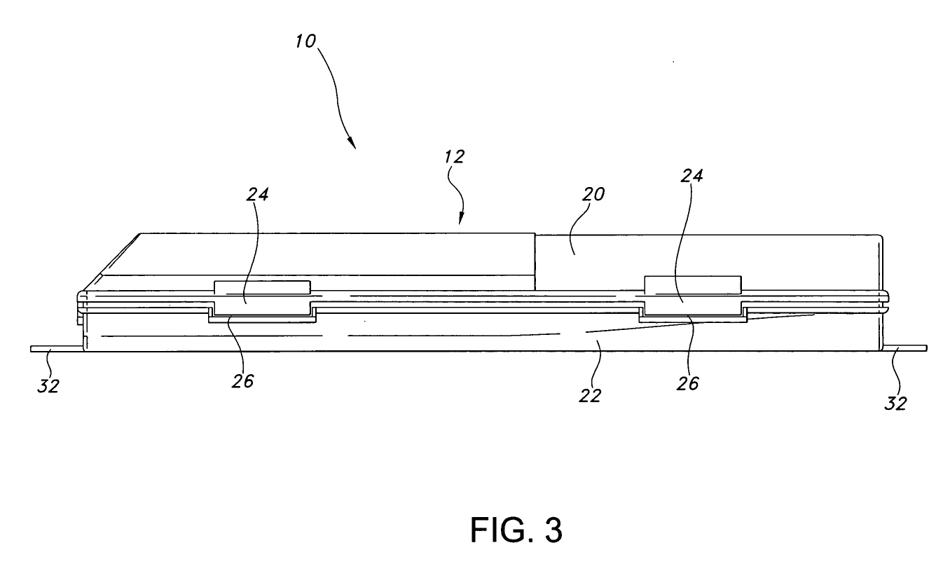

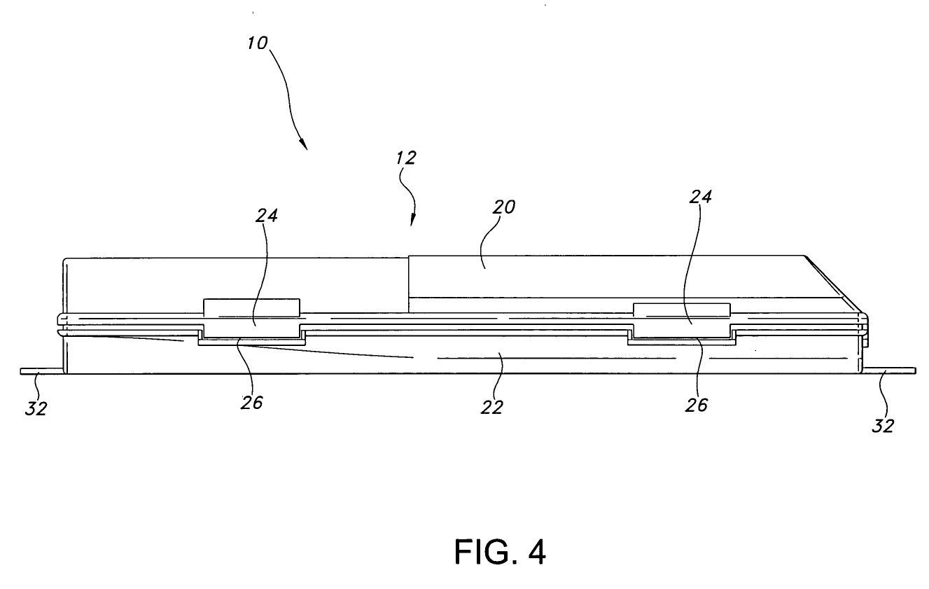

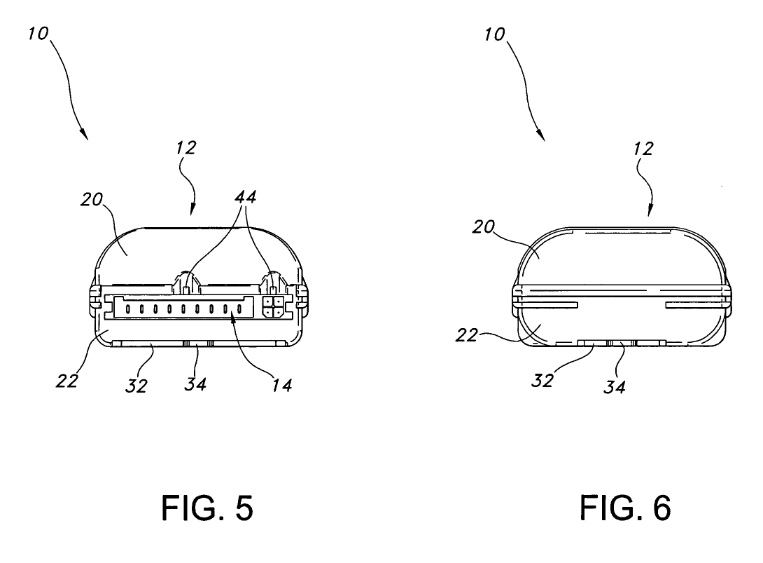

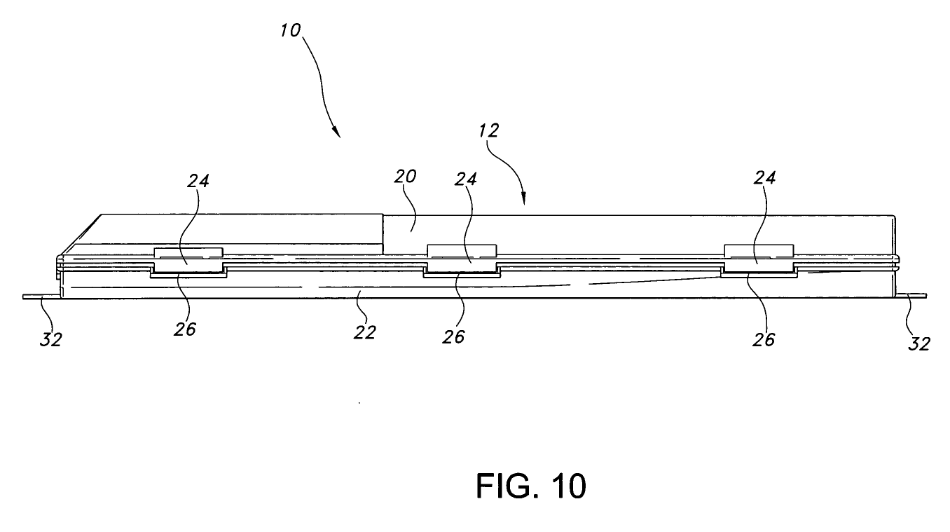

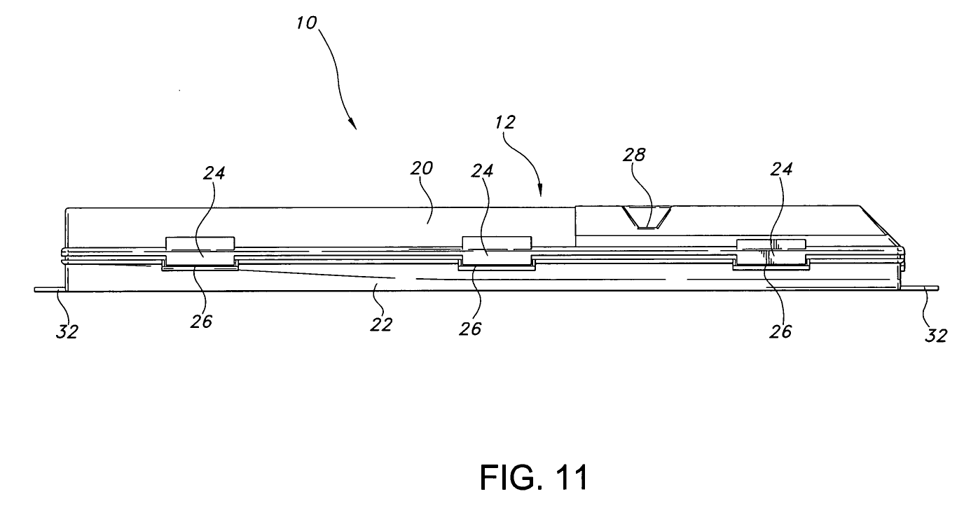

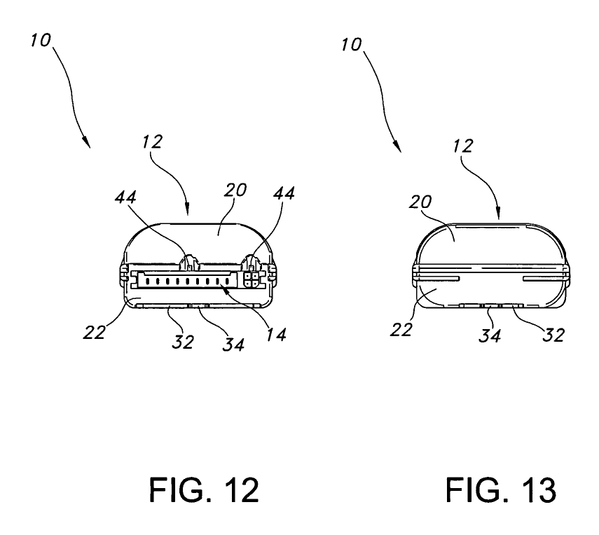

The emergency ballast 10 shown in the accompanying figures includes an outer housing 12 that at least partially encloses the emergency ballast's other components, which include, but are not limited to a header 14, circuitry 16, and one or more rechargeable batteries 18 (or another source of power) (shown schematically in FIGS. 21 and 23). Although the ballast's housing may be formed in any shape and configuration, the housing shown in the accompanying figures is formed of two shells 20 and 22 that are secured together. While any number of mechanical means may be used to secure shells 20 and 22 together, a snap-fit connection (as shown in FIGS. 2-4 and 9-11) has proved particularly useful in this application. Resilient tabs 24 extend from one of the shells (in this case shell 20) and engage slots 26 formed in the other shell (in this case shell 22) to secure the two shells together. The resilient tab 24 may include a lip at its distal end that snaps into and engages the slot 26. Once the lip snaps into the slot, it may be difficult for an individual to disengage the resilient tabs from the slots, deterring individuals from attempting to tamper with or otherwise modify the interior circuitry of the ballast.

The housing may be made from any material that exhibits sufficient structural integrity. Preferably, the housing is formed of plastic. More preferably, the housing is formed of a mineral reinforced polyphenylene oxide or polyphenylene ether high impact polystyrene. Alternatively, other resins may be used, such as polycarbonate or polyetherimide.

The housing may include one or more metal reinforcing inserts positioned proximate certain components of the ballast's circuitry. The insert may provide additional structural rigidity and mechanical integrity to the housing. In some embodiments, such as the embodiments shown in the accompanying figures, the reinforcing insert may be integral to one or both housing shells. In other embodiments, the reinforcing insert may be a separate piece which is located between the circuitry and the ballast's housing.

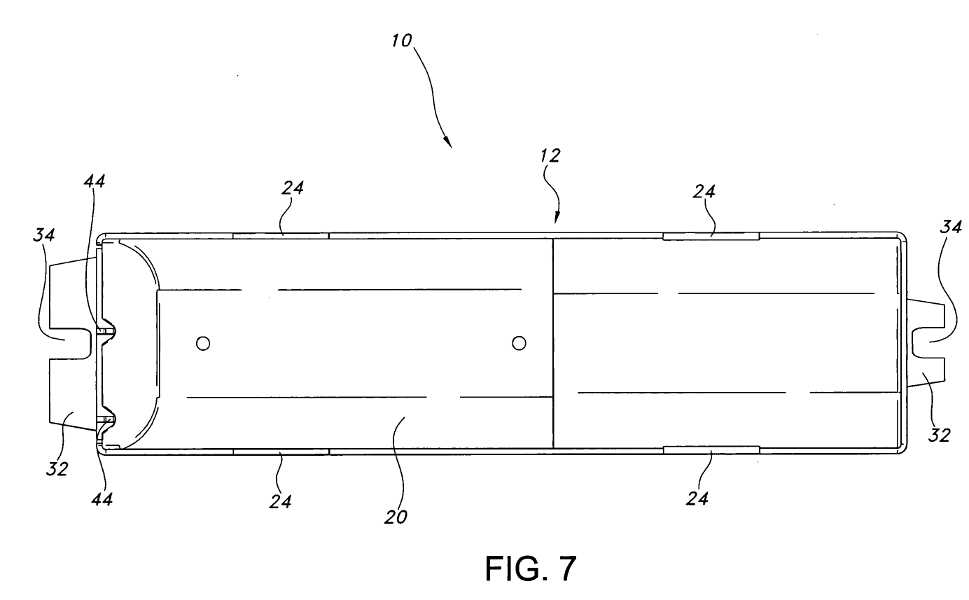

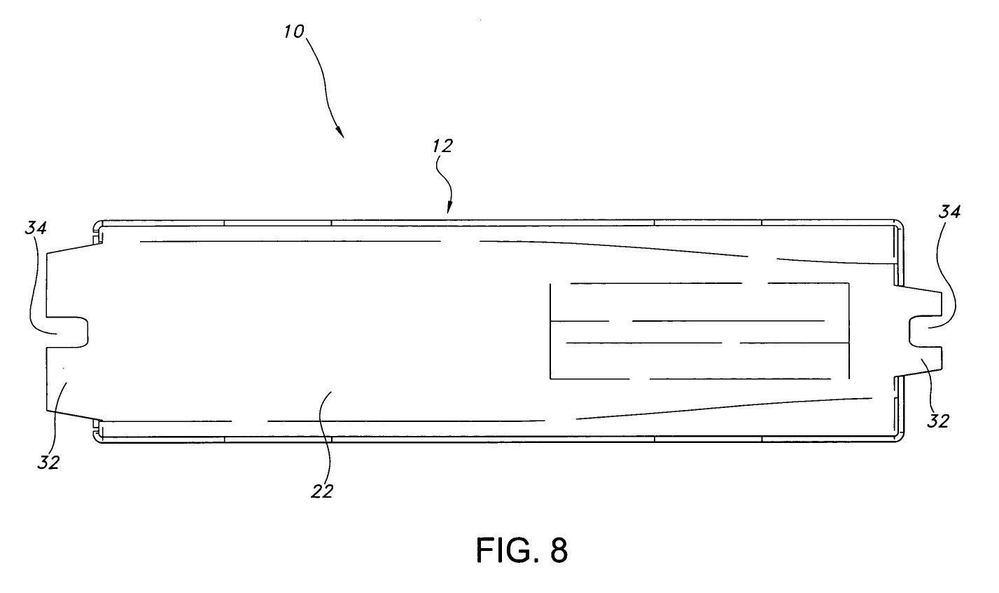

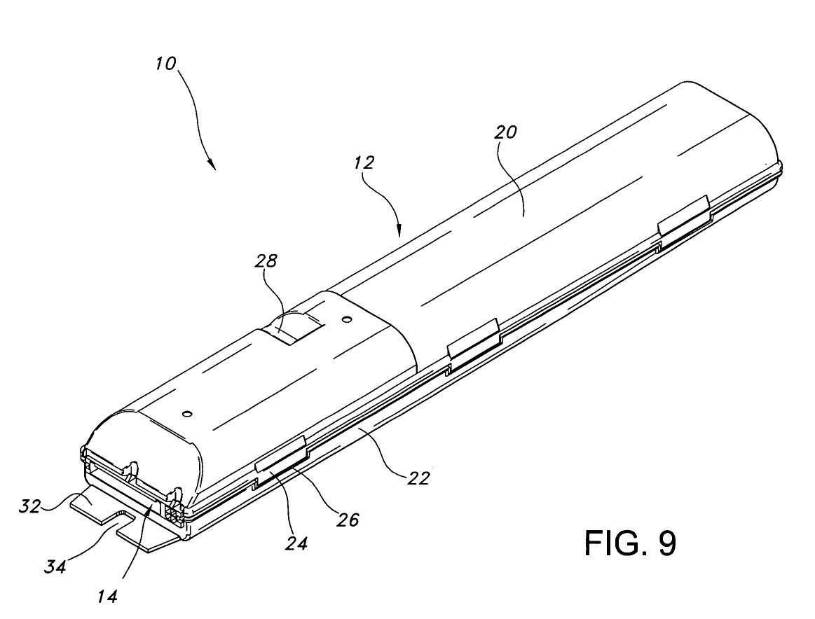

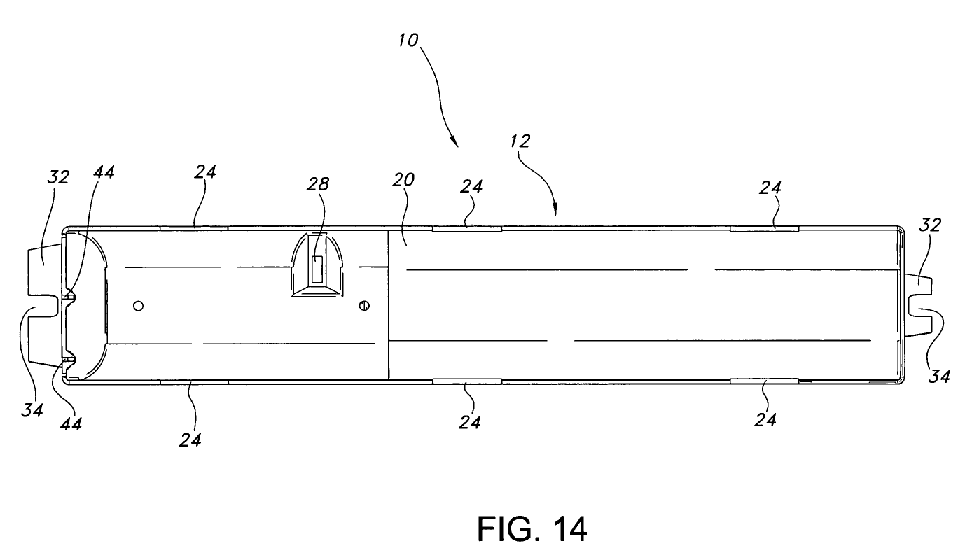

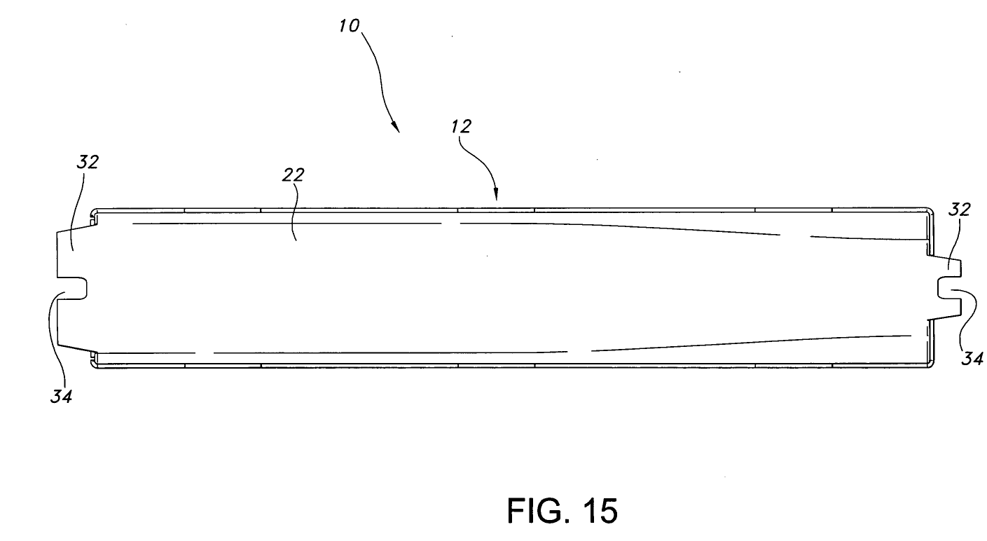

The emergency ballast's housing may also include an aperture 28 (see FIG. 9) for accessing a switch 30 (shown in FIG. 23) associated with the ballast's circuitry. The switch allows the installer or other user to select different settings (e.g. different “current output modes”) for the emergency ballast depending on the type and configuration of fluorescent lamps used in the fixture. The housing may also include one or more flanges 32 (see FIGS. 7, 8, 14, and 15) extending from the housing that include apertures or slots 34 for receiving screws, nails or other fasteners to secure the emergency ballast to the fluorescent lighting fixture. In some installations, the flanges may interact with features on the fixture, such as slotted portions, to secure the ballast to the fixture, eliminating the need for screws, nails or other fasteners.

As shown in FIGS. 21 and 23, the header 14 of the emergency ballast is electrically connected with the internal circuitry of the ballast and is exposed and accessible from the outside of the ballast's housing. The header is preferably mounted to an end of a circuit board and electrically connected to various portions of the emergency ballast's circuitry. The header may receive any number of external connectors. The external connectors can be associated with various wires of other components of the fluorescent lighting fixture such that connecting the external connectors to the header electrically connects the other components of the fluorescent lighting fixture to the emergency ballast's circuitry.

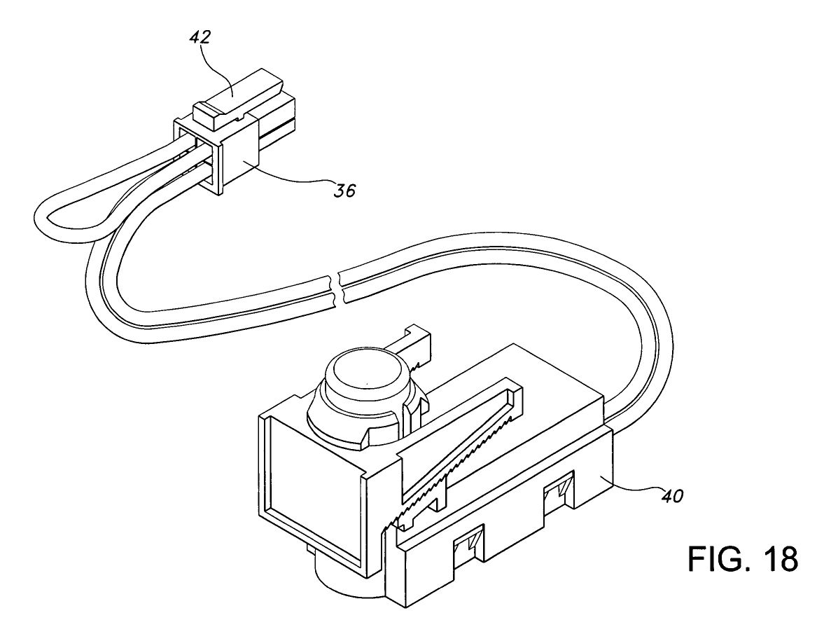

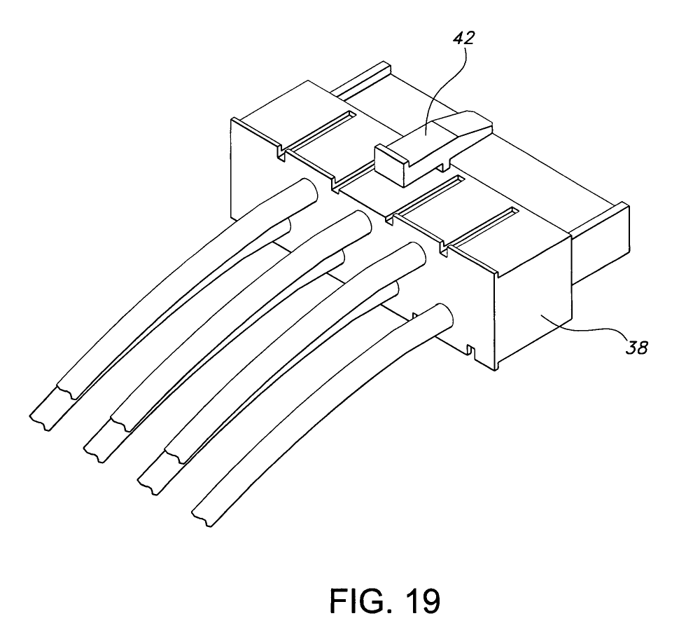

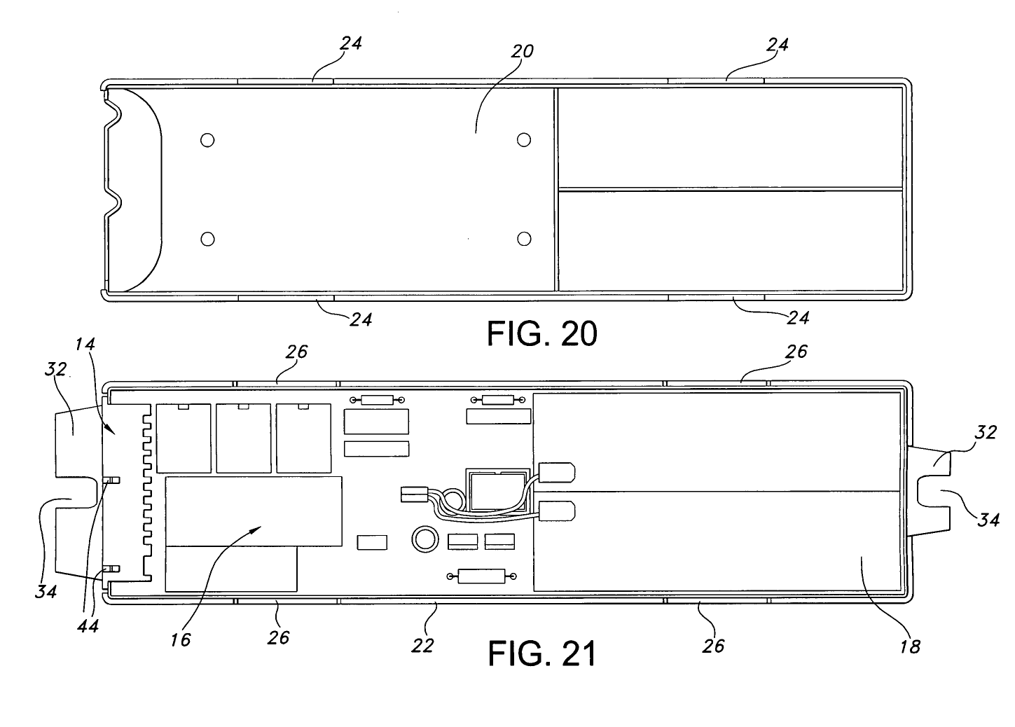

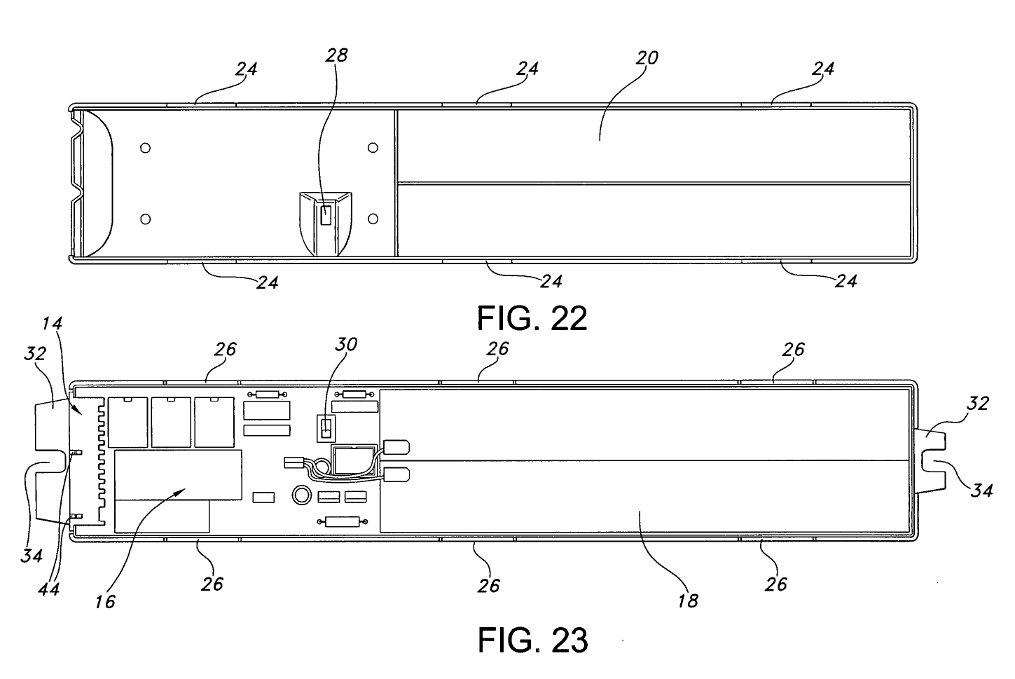

Numerous header and connector configurations are possible and within the scope of the present invention. The accompanying figures show two connectors: a four pin connector 36 (FIG. 18) and a multi-pin connector 38 (FIG. 19). Resilient tabs 42 engage protrusions 44 to secure the connectors to the header. As shown in the accompanying figures, the resilient tabs extend from the connectors and the protrusions are associated with the header. In the embodiments shown in the accompanying figures, the external connectors are “male” connectors and the header is a “female” connector, although other configurations are possible. In other embodiments, the external connector may be secured to the header in other manners, such as by screws, pins or other mechanical means. In still other embodiments, the external connector is not necessary, rather, although less preferably, the wiring of the other components may be connected directly to the ballast's header.

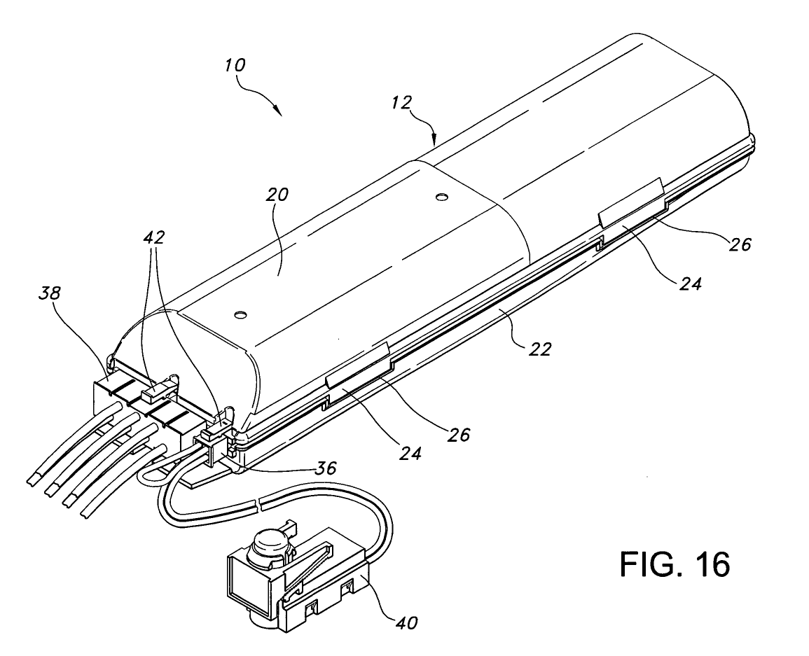

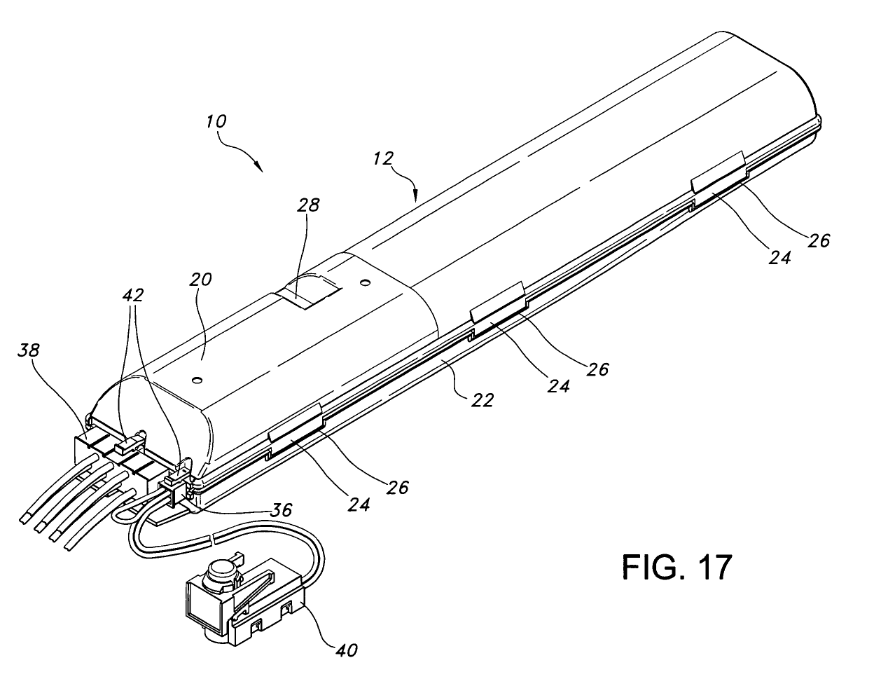

As shown in FIG. 16, the four pin connector connects a test switch/pilot light 40 to the emergency ballast's circuitry. The test switch/pilot light is illuminated when the emergency ballast is energized and functioning properly. To ensure that the emergency ballast is functioning properly, an individual can actuate the test switch to simulate a power outage. When the emergency ballast is installed in the fluorescent fixture, actuating the test switch may transfer the lamps from the fluorescent ballast to the emergency ballast for either a limited period of time or until the operator releases the test switch. In the embodiments shown in the figures, the test switch is actuated by depressing a button. In other embodiments, the test switch may be any other suitable structure or device for testing the functionality of the emergency ballast. In still other embodiments, the test switch and pilot lights may be separate devices. In such embodiments, the header may either be configured to receive connectors for both devices simultaneously, or alternatively, be configured to receive only one of the two devices at a time. In still other embodiments, removing the test switch/pilot light may de-energize the circuitry of the emergency ballast, allowing an individual to safely work on the unit.

The multi-pin connector shown in FIG. 19 connects other fixture components, such as the fluorescent lights, fluorescent ballast, and the power source, to the emergency ballast's circuitry. The multi-pin connector may connect to the wiring of the other fluorescent fixture components in any desirable manner. The connectors shown in the accompanying figures are “poke home” connectors (also known as “push nut,” “push wire” or “poke in” connectors). The connectors include a plurality of apertures, each of which are associated with one of the connector's contact pins. Inserting a stripped end of a wire into the aperture associates that wire with a contact pin such that when the connector is connected to the header, the wire is associated with a desired portion of the emergency ballast's circuitry. The connector may include color coding or other indications for identifying the appropriate aperture for each wire.

As shown in FIG. 1, emergency ballasts of the present invention are installed by mounting the emergency ballast in a fluorescent fixture's wire way 100, connecting the other component's wiring to the multi-pin external connector, connecting the multi-pin connector to the emergency ballast and/or connecting the test switch/pilot light to the emergency ballast. In other embodiments, the other component's wiring can be directly connected to the ballast's header.

Replacement of emergency ballasts in accordance with the present invention is relatively simple. First, the multi-pin connector, and optionally the test switch/pilot light, are disconnected and the emergency ballast requiring replacement is removed. Next, the new emergency ballast is secured in the fluorescent fixture's wire way and the original multi-pin connector, and optionally test switch, are reconnected. Alternatively, as discussed above, the multi-pin connector and four pin connectors are not necessary in all embodiments of the present invention.

Modifications, additions and deletions may be made to the embodiments described above and shown in the accompanying figures without departing from the scope or spirit of the present invention. For instance, some embodiments may not include a separate wiring connector for interfacing with the ballast's header. Rather, the header itself may be a “poke home” connector that directly connects to the wiring of the other fixture components. Also, material substitutions are possible for many, if not all, of the components described above (e.g., plastic could be substituted for metal components and vice versa).

1. An emergency lighting ballast for use with fluorescent fixtures, comprising:
(a) a ballast housing, the ballast housing substantially surrounding internal circuitry of the ballast and a rechargeable power source; and
(b) a header, at least a portion of which protrudes through the ballast housing, the header electrically associated with the internal circuitry;
wherein the header comprises one or more connection points, the connection points accessible from outside the ballast housing and electrically connecting one or more external wires to the internal circuitry.

2. The emergency lighting ballast of claim 1, wherein the external wires are directly connected to the connection points of the header.

3. The emergency lighting ballast of claim 1, wherein the external wires are electrically connected to the connection points of the header by at least one external connector.

4. The emergency lighting ballast of claim 3, wherein the at least one external connector comprises a multi-pin connector or a four pin connector.

5. The emergency lighting ballast of claim 3, wherein the at least one external connector comprises a multi-pin connector and a four pin connector.

6. The emergency lighting ballast of claim 3, wherein the at least one external connector is electrically connected to a pilot light or a test switch.

7. The emergency lighting ballast of claim 3, wherein the at least one external connector is electrically connected to a pilot light and a test switch.

8. The emergency lighting ballast of claim 3, wherein the at least one external connector comprises a poke-home connector.

9. The emergency lighting ballast of claim 8, wherein the at least one external connector comprises a male connector and wherein the header comprises a female connector.

10. The emergency lighting ballast of claim 1, wherein the internal circuitry and the header are associated with a circuit board.

11. An emergency lighting ballast for use with fluorescent fixtures, comprising:
(a) a ballast housing, the ballast housing substantially surrounding internal circuitry of the ballast and a rechargeable power source; and
(b) a header, at least a portion of which protrudes through the ballast housing, the header electrically associated with the internal circuitry;
wherein the header comprises one or more connection points, the connection points accessible from outside the ballast housing and electrically connecting one or more external wires to the internal circuitry and wherein the external wires are electrically connected to the connection points of the header by at least one external connector.

12. The emergency lighting ballast of claim 11, wherein the at least one external connector comprises a multi-pin connector and a four pin connector.

13. The emergency lighting ballast of claim 11, wherein the at least one external connector is electrically connected to a pilot light or a test switch.

14. The emergency lighting ballast of claim 11, wherein the at least one external connector comprises a poke-home connector.

15. The emergency lighting ballast of claim 11, wherein the at least one external connector comprises a male connector and wherein the header comprises a female connector.

16. The emergency lighting ballast of claim 11, wherein the internal circuitry and the header are associated with a circuit board.

17. A method of installing an emergency lighting ballast in a fluorescent light fixture, comprising:
(a) locating and securing an emergency lighting ballast in a fluorescent light fixture, the emergency lighting ballast comprising:
(i) a ballast housing, the ballast housing substantially surrounding internal circuitry of the ballast and a rechargeable power source; and
(ii) a header, at least a portion of which protrudes through the ballast housing, the header electrically associated with the internal circuitry;
wherein the header comprises one or more connection points, the connection points accessible from outside the ballast housing and for electrically connecting one or more external wires to the internal circuitry; and
(b) electrically connecting wires of the fluorescent light fixture to the header of the emergency lighting ballast.

18. The method of installing an emergency lighting ballast in a fluorescent light fixture of claim 17, wherein electrically connecting wires of the fluorescent light fixture to the header of the emergency lighting ballast further comprises connecting the wires of the fluorescent light fixture to an external connector and connecting the external connector to the header of the emergency lighting ballast.

19. The method of installing an emergency lighting ballast in a fluorescent light fixture of claim 18, further comprising:
(a) disconnecting the external connector from the header of the emergency lighting ballast;
(b) removing the emergency lighting ballast from the fluorescent lighting fixture;
(c) locating and securing a second emergency lighting ballast in the fluorescent lighting fixture; and
(d) electrically connecting wires of the fluorescent light fixture to the header of the second emergency lighting ballast.

20. The method of installing an emergency lighting ballast in a fluorescent light fixture of claim 17 further comprising: electrically connecting a pilot light and test switch to the header of the emergency lighting ballast.
